(19) United States
(12) Patent Application Publication
(10) Pub. No.: US 2013/0332254 A1
(43) Pub. Date: Dec. 12, 2013

(54) METHOD, SYSTEM FOR CONSUMER LOCATION TRIGGERED REWARD POINTS

(71) Applicant: FLYING COLORS TECHNOLOGY LIMITED, Tsimshatsu Hong Kong (CN)

(72) Inventors: Wing-Fung Yu, Hong Kong (CN); Jason Felix Tsz-Kiu Chiu, Hong Kong (CN)

(21) Appl. No.: 13/908,199

(22) Filed: Jun. 3, 2013

(30) Foreign Application Priority Data
Jun. 6, 2012 (CN) 201210184863.X

(51) Int. Cl. G06Q 30/02

(52) U.S. Cl. CPC G06Q 30/0226
USPC 705/14.27

(57) ABSTRACT

A method and system for offering reward options to consumers is disclosed. Offering of the reward options is triggered when a consumer visits certain locations. A server of the system is able to obtain the position of the mobile terminal of the consumer, and to determine if the mobile terminal is in the vicinity of any such location. If so, the server is triggered to offer a reward to the mobile terminal. The server stores records of visits to such locations. Alternatively, or additionally, the server stores records of reward options which have been accepted via the mobile terminal, and provides at least one selectable reward to the mobile terminal according to an updated visit record and/or reward acceptance record.

### CROSS REFERENCE TO RELATED APPLICATIONS

This application claims priority to Chinese Application No. CN 201210184863.X filed Jun. 6, 2012; this application is hereby incorporated by reference herein as if fully set forth in its entirety.

### FIELD OF THE INVENTION

This invention relates to the field of communication technology. More particularly, this invention relates to a method, system for location-triggered consumer reward points.

### BACKGROUND OF THE INVENTION

Large retail merchants, such as chain stores, supermarkets, electrical appliance retailers or catering businesses, tend to entice consumers to make continual purchases by issuing store memberships or regular shopping reward schemes, such as the Ponta reward scheme of Lawson in Japan, the Star Reward options scheme of Macy's Inc. in the U.S., the Moneyback reward scheme of ParknShop in Hong Kong or the reward scheme of China Mobile.

It is generally known that the cost of attracting a new consumer is 6 times that of simply maintaining the continual patronage of an existing consumer. Thus, it is believed that reward schemes, by sustaining consumer loyalty, are a cost-effective measure for building a business.

Unfortunately, the cost of designing and implementing a reward scheme which is tailored to specific consumer traits is high, particularly due to the cost of setting up servers, database and software to record and to process consumer data. This imposes an entry barrier usually beyond the financial and infrastructural means of small and medium size shops. As a result, small and medium size shops tend to use manually managed membership schemes, instead of consumer-specific but complicated computer-implemented reward schemes.

It is therefore desirable to propose a method and system which provides the possibility of meticulous consumer reward schemes, which are easily implementable by small and medium size businesses.

### SUMMARY OF THE INVENTION

In a first aspect, the invention proposes a method for providing consumer location-triggered reward points, comprising the steps of: providing a server; the server determining whether a mobile terminal belonging to a consumer is in a pre-determined location; if so, triggering the server to provide at least one reward point to the consumer if the mobile terminal is in the pre-determined location.

A ‘pre-determined location’ refers to a shop, such as a retail outlet. Therefore, the consumer may only visit retail outlets in order to be offered reward points. Optionally, a ‘pre-determined location’ could also refer to non-business locations which could indicate purchasing interests of the consumer, such as premises of universities.

Preferably, the method further comprises the step of: selecting the at least one reward option from a database of a plurality of reward options, the at least one reward option being redeemable by the reward points of the consumer; and offering the at least one reward option via the mobile terminal.

Preferably, the at least one reward option is also selected to be offered because it was provided by a ‘pre-determined location’ which the mobile terminal was brought into. Rewards options offered in this manner are more likely to entice purchases successfully, since the consumer owning the mobile phone has visited the pre-determined location before and is likely to have some interest in goods or services offered in the pre-determined location.

Optionally, the at least one reward option is selected for being provided in the pre-determined location, which reward options have been accepted by the consumer in the past. Rewards options selected in this manner are more likely to entice purchases successfully, since the consumer has accepted the rewards offered by the pre-determined location before.

Preferably, the reward options are sorted to show those offered by shops nearest to the current location of the mobile terminal. In other words, the at least one reward option is selected for the proximity of the nearest pre-determined locations offering the at least one reward option to the present location of the mobile terminal. In this case, the more accessible and convenient of the reward options displayed are first, which could further encourage spending.

Preferably, the method further comprises the step of: ordering the reward options such that, reward options provided by pre-determined locations of which reward options have been accepted by the consumer in the past are displayed first. This improves the relevance of the reward options displayed first, further encouraging spending. This feature is particularly relevant to shops that offers reward redemption online, where consumer visitation to a physical retail outlet is not so relevant.

Preferably, there is a pre-set limit to the number of reward points that can be awarded within a timeframe for making multiple visits to a pre-determined location.

Optionally, the method further comprising the step of: awarding a class or medal to the mobile terminal if the mobile terminal has made a minimum number of visits to one or more pre-determined locations.

Optionally, the method further comprising the step of: the server pushing, or sending, advertisements to the mobile terminals. Preferably, the number of advertisements that can be pushed within a predefined timeframe to the mobile terminal is pre-limited.

Accordingly, the invention provides the possibility to determine via wireless positioning which shop is the consumer is visiting currently, or has visited. This leads to the further possibility of offering the consumer reward options according to the shops he has visited. In this way, reward options are offered based on behavioral data of the consumer. This improves the effectiveness of consumer loyalty programs and also gives the consumer a pleasant shopping experience.

As the invention provides the possibility of analyzing and tracking the shopping characteristics of consumers, such as products preferences, shopping patterns, shop visit frequencies and reward preferences, it is also possible to distinguish between consumers of different purchasing intensity by awarding ‘class’ types and ‘medals’ to the consumers.

Furthermore, the invention provides the possibility of enhancing the personal shopping experience without requiring the small and medium shops to purchase expensive CRM (consumer relationship management) software.

Accordingly, the invention provides the possibility of a low-cost method to create a consumer reward program, in which a sharing platform is provided for different shops to reward consumers collectively. This improves the competitive edge of small and medium shops against larger shops.

In a second aspect, the invention proposes a system for consumer location-triggered reward, comprises a server and several mobile terminals, the server and mobile terminals are connected via a mobile communication network; the server comprises: a consumer database, used for storing records of visit history of the mobile terminal to specific places and/or a reward acceptance record made from the mobile terminal, the mobile terminal is related to one consumer; a positioning module, used for positioning the mobile terminal, determine whether the mobile terminal is in the vicinity of the location; if so, the server would update the visit record, a reward module, used for providing at least one selectable reward to the mobile terminal according to the updated visit record and/or reward acceptance record, and updating the reward acceptance record in the consumer database according to the reward selected from the mobile terminal.

The invention provides the possibility of determining the position of mobile terminals in order to determining if a location which the terminal has been brought into is that of a shop. In this way, a historical record of shops that a mobile terminal owner, i.e. a consumer, has visited can be recorded. According to the visit record, and/or reward acceptance record of the consumer, a shop may now to offer the consumer an effective and attractive reward. Also, the reward offers of certain goods and services could be increased according to the consumer's visit frequency to certain shops selling those specific goods or services, to provide the consumer a better shopping experience.

### BRIEF DESCRIPTION OF THE DRAWINGS

It will be convenient to further describe embodiments of the present invention with respect to the accompanying drawings that illustrate possible arrangements of the invention, in which like integers refer to like parts. Other embodiments of the invention are possible, and consequently the particularity of the accompanying drawings is not to be understood as superseding the generality of the preceding description of the invention.

FIG. 1 provides the application diagram of this invention of the system for consumer location-triggered reward;

FIG. 2 provides the preferable application diagram of this invention of the system for consumer location-triggered reward;

FIG. 3 provides the flow chart of this invention of the method for consumer location-triggered reward;

FIG. 4 is the first embodiment of this invention providing the flow chart of the method for consumer location-triggered reward;

FIG. 5 is the second embodiment of this invention providing the flow chart of the reward points calculating to the mobile terminal 200;

FIG. 6 is the third embodiment of this invention providing the flow chart of advertisement pushing;

FIG. 7 is the fourth embodiment of this invention providing the flow chart of location data pushing; and

FIG. 8 is the fifth embodiment of this invention providing the flow chart of lifecycle marketing analysis.

### DETAILED DESCRIPTION OF PREFERRED EMBODIMENTS

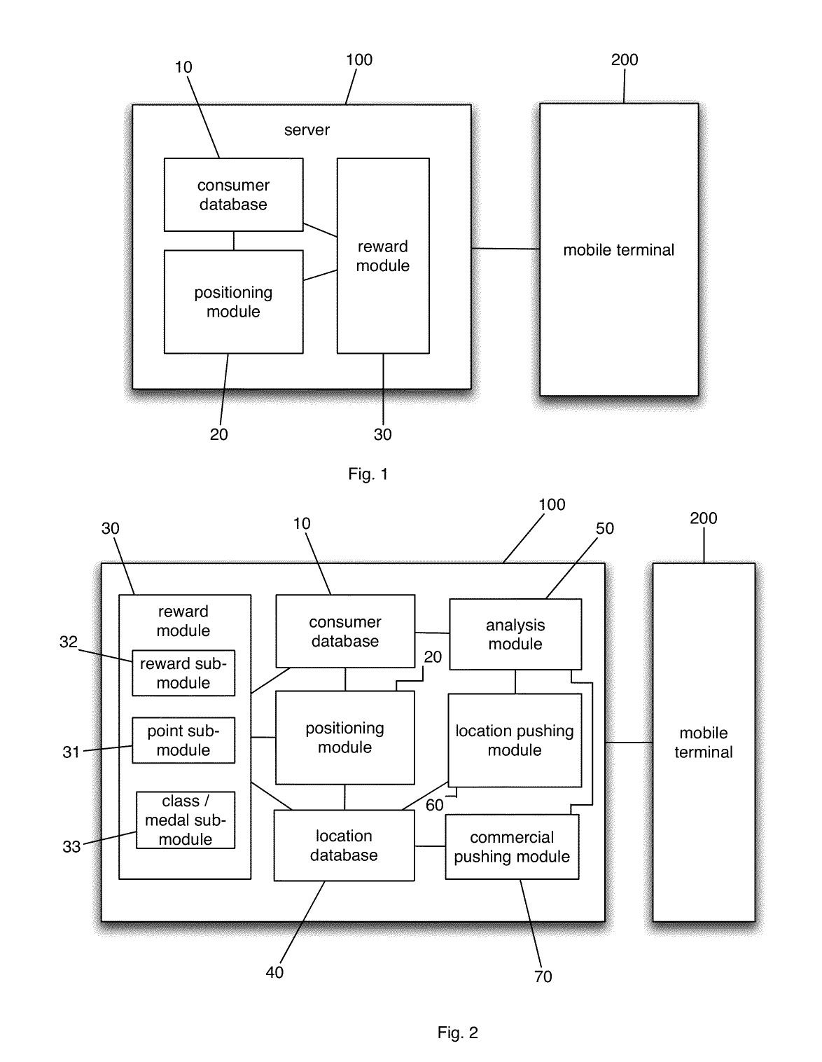

FIG. 1 illustrates the structure of a system for issuing location-triggered reward options to consumers.

The reward system comprises a server 100 and at least one mobile terminal 200 with a link to the server 100 via a mobile communication network. It is generally assumed that the mobile terminal 200 is related to one person, which is the owner of the mobile terminal, called the ‘consumer’ here. Therefore, the mobile terminal 200 can be used to identify a reward account of the consumer.

The mobile terminal 200 used by a consumer could be a smartphone, PDA (Personal Digital Assistant), tablet, notebook, specifically could include the Apple iPhone. Apple iPod Touch, Apple iPad, Android cell phone, Android tablet, RIM BlackBerry cell phone, Windows Phone, Nokia S60 cell phone and other mobile terminals 200 that could run the application programming.

Generally, there is a communication module in the mobile terminal 200 to communicate with the mobile communication network.

The mobile communication networks may be the GPRS (General Packet Radio service) network, WCDMA (Wideband Code Division Multiple Access) network, CDMA2000 (Code Division Multiple Access 2000) network, TD-SCDMA (Time Division-Synchronous Code Division Multiple Access) network, HSDPA (High Speed Downlink Package Access) network, TETRA (Terrestrial Trunked Radio) network, LTE (Long Term Evolution) network, Wireless network, WiMAX (Worldwide Interoperability for Microwave Access) network, Bluetooth network and other matched communication networks. The mobile terminal 200 matches at least one of the standards of the mobile communication networks, the mobile terminal 200 could communicate with the server 100 and networks by using mobile communication networks via the IP (Internet Protocol) and other communication protocols.

The mobile terminal 200 has the necessary hardware and software to determine its current location, which may comprise any outdoor positioning technology and/or any indoor positioning technology. The outdoor positioning technology may include the GPS (Global Positioning System), the Assisted GPS or a more accurate positioning function calculated by the application programming itself. Indoor wireless network positioning technology may include: neighboring ultrasound positioning system (recited by China patent application CN201210030372.X, U.S. patent application Ser. No. 13/763,275), terminal permission verification positioning system (recited by China patent application CN 201210129060.4, U.S. patent application Ser. No. 13/872,959), wireless network SSID positioning (recited by China patent application CN200810180327.6), Bluetooth beacons, mobile network transmitter etc. Other indoor positioning technologies may include neighboring ultrasound positioning system. Bluetooth beacons etc., to provide more accurate indoor positioning. These technologies can differentiate between different floors and different departments in an arcade, or even different retail areas within in one floor.

The server comprises a positioning module 20. The positioning module 20 relies on location feedback from the mobile terminal 200 to confirm whether the current location of mobile terminal is in a ‘pre-determined location’. Typically. ‘pre-determined locations’ are shops which are members of the reward system. However, the ‘shop’ here may include retail stores, cinemas, sightseeing spots, playgrounds, universities, or even large shopping arcades comprising a plurality of departments. ‘Departments’ may refer to different units of a same shop each relating to different goods or services. For example, while a multi-level large shopping center supermarket or an arcade is in fact one shop or business entity, the different departments which sell different goods such as domestic electrical appliances, domestic grocery, food, clothing and so on, are considered different ‘shops’ for the purpose of this embodiment.

The server 100 comprises a consumer database 10, used to record the number of times the mobile terminal has been brought into any of the shops.

The server also comprises a reward module 30. The reward module 30 issues reward points to the consumer for visiting any shops. For example, if the consumer carries the mobile terminal 200 into a bakery, which is a member shop of the embodiment, one reward point is allocated to the consumer's reward account (preferably stored and recorded in the server). Subsequently, if the consumer carries the mobile terminal 200 into a wine shop, two reward points may be allocated to the consumer's reward account. The reward points are accumulated and recorded in the consumer database 10. Eventually, the reward points may be used to exchange for rewards. Thus, the consumer will receive a reward point just for being in the shop. In this way, the consumer is encouraged to visit the shops regularly, thereby increasing customer loyalty.

Typically, the consumer is still in the current shop he is visiting when the latest reward points are updated. As soon as a reward point has been updated in the consumer database 10, and if the server detects that sufficient reward points have been accumulated for the consumer to exchange the reward points for certain rewards, the reward module 30 selects the most suitable or relevant reward options for the consumer from a collection all the reward options offered by member shops, and sends at least one reward option to the mobile terminal 200. If the consumer would like to accept the reward option, he can do so via the mobile terminal.

Typically, the reward options may be cash or discount coupons (for any goods or service), goods or service coupons, and so on, offered by the member shops.

Although reward options are selected depending on whether the accumulated reward points are sufficient for reward redemption, the reward options may also be selected because they are offered by shops which the mobile phone has been brought to. This allows the reward options to be more likely appreciated or desired by the consumer, since he probably has visited those shops before.

It is preferable the reward options are sorted such that those reward options offered by shops which the consumer has most frequently visited in the past are displayed to be seen first in the mobile terminal 200. This could also entice spending as such reward options are likely to be of interest to the consumer.

The past visits to shops are recorded in the consumer database 10. Other than to provide rewards options offered by shops which the consumer has visited before, these records allow the server to analyze and deduce the purchasing interests of the consumer. For example, if the consumer has visited the electronic appliance department of large shopping arcades many times, it would seem that he has an interest in such products. Furthermore, if it is detected that the consumer is always in the fine arts faculty of the university, it may imply that he is either a student or a lecturer and has specific interest to buy art equipment such as paper and easels, or books of specific topics.

The consumer database 10 also stores the consumer's personal data. The consumer's personal data is also known as the consumer's static data that is input and updated by the consumer via the API of the Internet and mobile terminal 200. The consumer's personal data may comprise anything from the simplest account number and password, to the most general personal data, including gender, age, income, shopping preference, future shopping plans, housing, family status and so on. In a variation of the embodiment which provides more privacy, the consumer is required to provide only an account number and password. However, where processing personal data by large institutions is generally trusted by the public, the consumer may provide more comprehensive personal data.

Optionally, the mobile terminal has an API (Application Programming Interface) which allows the consumer to indicate to the server the maximum number of reward options that he is willing to be offered via the mobile terminal within a pre-determined timeframe, such within an hour or within a day. Limiting the number of reward options prevents the consumer from being overwhelmed by too many reward options, and improves the consumer attention paid to the fewer reward options offered.

The consumer database 10 also contains a reward acceptance record, that is, a record of reward options that the consumer has accepted in the past via the mobile terminal 200. The consumer database 10 also records include the total number of such reward options, as well as the frequency of acceptance of such reward options. Based on this reward acceptance record, it is possible for the reward module 30 to select reward options from the same shops of which past reward options were accepted by the consumer. In this case, it is preferable that reward options from shops of which rewards were most accepted in the past by the consumer are ordered to be displayed first in the mobile terminal 200.

Yet more preferably, reward options which are both offered by shops that the consumer has most visited, and which are also the reward options that were most accepted by the consumer, have priority of display.

If there is no record of past shops visit or past reward acceptance, the reward options would be sorted to display those reward options offered by shops physically nearest to the current position of the mobile terminal 200.

FIG. 2 is more detailed illustration of the embodiment, showing that the server 100 comprises a consumer database 10, a positioning module 20, a reward module 30, a location database 40, an analysis module 50, a location pushing module 60 and/or an advertisement pushing 70.

FIG. 2 shows that the reward module 30 comprises a reward point sub-module 31, a reward sub-module 32 and a class (or medal) sub-module.

As described for FIG. 1, the consumer database 10 records the number of times the mobile terminal 200 was brought into shops and/or the reward options which were accepted via the mobile terminal 200.

The location database 40 stores reward point rules, location data and reward rules for each location.

As mentioned above, the reward point sub-module 31 counts the reward points awarded to the mobile terminal 200 according both to the visits made to shops and according to reward point rules.

a. Reward points are awarded according to the reward point rules. Typically, the reward point rules may specify the maximum reward points that each consumer may be awarded for visiting the same shop within a timeframe, such as a day. This is regardless of how many times does the consumer visit the shop within the timeframe. An alternative rule may specify that one consumer could gain reward points several times by visiting the same shop several times in a day but, for example, for not more than five times. The rules may also specify a certain time lapse between each visit, such as one hour, in order for a reward point to be awarded.
b. The reward point rules may also specify the maximum number of reward points that each consumer could be awarded for visiting a large shop such as an arcade of many different departments. For example, there may be a cap to the total number of reward points that each consumer could gain per day for visiting the shop, regardless of the different departments visited. Also, the reward points awarded for visiting the different departments may be different.
c. Alternatively, the reward point rules may specify that no reward point is awarded for a specific shop, although a visit would still be updated in the visit record.

The location data relate to the location of the shops, and is used by the server to determine if the current location of the mobile phone is that of a shop. The data includes the name of the shop, goods and service types provided by the, operating hours or other information of the shop. The data also includes the shop's geographical coordinates such as its longitude, latitude, height above sea level. Furthermore, the data includes the shop's official address, web address, working hours, promotional or advertising material and data etc.

a. For a large shopping center or arcade, the arcade's static data such as the arcade's name and address may be common to the different departments in the arcade. The different departments could be selling different goods such as domestic electrical appliance, grocery, food, clothing etc. These different departments trigger the server to award different reward points when the consumer visits them.

When the consumer is in a shop, the reward sub-module 32 is triggered to provide at least one selectable reward to the consumer according to the accumulated reward points, reward rules and, optionally, the reward acceptance record.

a. The reward rules may specify different reward plans that the server may be triggered to implement for each shop. For example, the reward rules may also specify for different shops the required reward points of redeeming specific reward options, specify the rewards' expiry dates, the reward types and the number of reward options to award.
b. Preferably, the reward module 30 provides reward options to the mobile terminal 200 in a sorted order of relevance to past accepted reward options. Reward options from the same shops that had offered reward options which were selected frequently by the consumer in the past would be placed first. If there were no history of reward acceptance, the reward options would be ordered according to the distance of the shops that offer the reward options to the current position of the mobile terminal. The reward options of the nearest shops will be displayed first.

The server 100 also comprises an analysis module 50. It is the analysis module 50 which deduces the shopping characteristics of the consumer, such as by analyzing the visits which the mobile terminal made to shops. Furthermore, the analysis module 50 analyzes the shopping preference of the consumer from the type of shops visited, the season or time of the visits.

Furthermore, the analysis module 50 analyzes the reward characteristics of the consumer, such as whether the consumer tends to prefer coupons, free gifts or discounts.

Furthermore, the analysis module 50 also analyzes the shops' data. Furthermore, the analysis module 50 also analyzes lifecycle marketing according to the consumer's personal data, to predict shopping preferences of the consumer.

Typically, the reward module 30 includes an API. The consumer could choose the reward order via the API. The API can also be used for accessing the Internet, displaying the reward options redeemed by reward points to consumer via the mobile terminal and recording the consumer's reward acceptance and providing reward options to the consumer.

Optionally, the server has a class/medal sub-module 33 which awards class or medal status to the consumer, based on the shop visit record, and stores the awarded class or medal in the consumer database 10. In this case, the reward point sub-module 31 calculates reward points to award to the consumer according to the shops visited, as well according to reward point rules and the consumer's awarded class. For example, the consumer classes are ‘general’, ‘silver’. ‘gold’ and ‘diamond’, and these classes are awarded and updated by the reward module 30 according to the frequency of the consumer visiting the shops. When being awarded reward points, a class silver consumer gains 1.25 times of the reward points of a general class consumer. A gold consumer gains 1.5 times of reward points of a general consumer. A diamond consumer gains 2 times of reward points of a general consumer.

A consumer could also be awarded medals. Examples of conditions for gaining a medal are: the first five consumers visiting the retailers of a shop most frequently in a timeframe, the first five consumers visiting the same arcade (including all shops within the arcade) most frequently in a same timeframe, the first five consumers visiting the same type of shops (including all daily grocery shops, digital electronic product shops in the same field) most frequently in the same timeframe.

In this case, the consumer database 10 contains the consumer's dynamic data, which comprises the visit record, reward acceptance record of the consumer, and also the class data and medal data of the consumer. The visit record comprises the data of consumers visiting the shops: the visiting date, time, shop's name, shop's type and any of the original data required in the data mining for the analysis module 50.

Optionally, the server 100 also comprises a location pushing module or a shop pushing module 60. The consumer may use the API to request the shop pushing module 60 to provide a list of shops near the current position of mobile terminal 200. The positioning module 20 in the mobile terminal 200 provides the current position to the server and in response, the shop pushing module 60 response with a list of shops who are members of the reward system. The shops are preferably according to the shopping characteristic analyzed by the analysis module 50, or by their proximity to the mobile terminal 200. However, other sorting preferences may be set by the consumer via the API.

The consumer could determine how the reward order format via the API of the mobile terminal 200. However, the default order could be made according to a general understanding of the consumer's behavior. For example, if the consumer visits digital electronic product shops most frequently in weekends, then digital electronic product shops would be shown in higher priority during weekends. If the consumer visits grocery shops most frequently on Sundays, then daily grocery shops would be shown in the higher priority on Sundays. Catering shops would be shown higher in priority around mealtimes.

The server 100 also comprises an advertisement pushing module 70 for pushing advertisements to the mobile terminal 200, preferably according to the shopping characteristic, advertisement rules and advertisement contents of the related consumer. The location database 40 stores the advertisement rules and advertisement contents. The advertisement rules determine the maximum number of advertisements that may be pushed to a mobile terminal 200 within a predefined timeframe. This could be a limit set by the system automatically or by the consumer, to enhance the effectiveness of advertisement so that the consumer is not overwhelmed by too much advertisement.

The shops' location data comprise the shops' dynamic data, advertisement, reward rules such a specification of the maximum number of advertisements that could be sent to the same consumer, the time rules of when to send advertisements, the distance rules of sending etc.

To enhance the effectiveness of advertisement, advertisement rules are specified. The rules may determine that an advertisement is sent not more than three times in a week, or that catering advertisements could be only sent in lunch and dinner time, or that some advertisements could be only sent when the consumer is within a certain distance of the shop advertised, such as within 1 km, which means the consumer could arrive the shop in 15 minutes on foot.

Relating to the API (Application Programming Interface), the major functions of the API are:

1. Providing an interface to let the consumer sign up for consumer reward schemes, and allows the consumer to input and update the personal data (also known static data which generally do not change). Furthermore, the interface displays show the consumer's class and medal status.
2. Providing an interface to let the consumer determine the different order of displaying shop information, such as by ordering the shops by distance, or by the relevance of shops to the consumer's purchasing interests. Furthermore, the interface provides the reward options to the consumer so that he may accept the reward options. Furthermore, the consumer may use the interface to click on shops' websites.
3. Providing an interface to let the consumer order the sequence of reward options according to the distance of shops offering such reward options.
4. Providing an interface for the consumer to communicate with the positioning-module 20, in order to determine if the position of the mobile terminal is at that of a shop;
5. Allowing the mobile terminal to communicate with the positioning-module 20 and to showing the medals that the consumer has gained by visiting a particular location. Preferably, the interface shows the medal gained automatically when the consumer is in the shop wherein the consumer is awarded with the medal;
6. Allowing the mobile terminal to communicate with the advertisement pushing module 70, and to display advertisement sent by the server 100 to the mobile terminal 200.

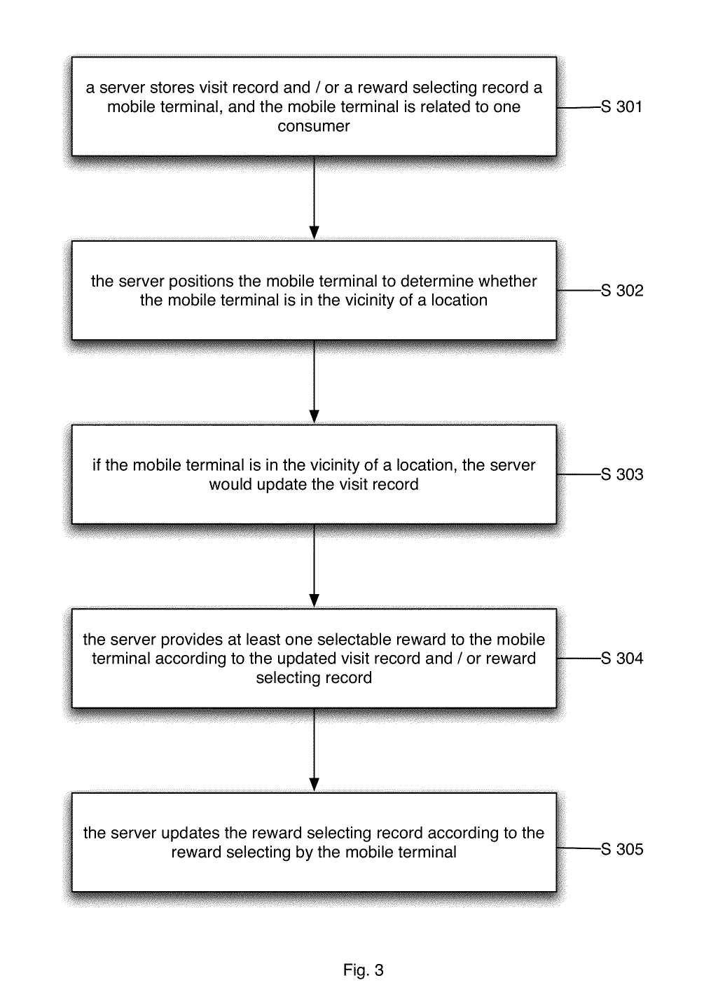

FIG. 3 is the flow chart of the embodiment which could be implemented via the server 100 of reward system and the mobile terminal 200 illustrated in the FIG. 1 or FIG. 2.

Step S301, the server 100 stores records of visit history of a specific location by a mobile terminal 200 and/or reward acceptance record made from the mobile terminal 200, it could correspond to the shopping account of the consumer to the mobile terminal 200. Preferably, the location is a shop and its department; the shops could be arcades, stores, cinemas, sightseeing spots, playgrounds etc.; the departments mean the different units of a shop. For example, a supermarket of two floors in an arcade is one shop; there are different departments in the shop, such as domestic electrical appliance, domestic grocery, food, clothing etc. The visit record comprises the frequency and time that the consumer visits the location, the reward acceptance record comprises the frequency of various reward options that the consumer selects.

Step S302, positions the mobile terminal 200, determine whether the mobile terminal 200 is in the vicinity of the location. Preferably, the mobile terminal 200 is positioned via the outdoor positioning technology and/or the indoor positioning technology.

Step S303, if the mobile terminal 200 is in the location, the server 100 would update the visit record.

Step S304, the server 100 provides at least one selectable reward to the mobile terminal 200 according to the updated visit record and/or reward acceptance record. The reward module 30 provides the reward options to the mobile terminal 200 in a descending order according to the reward acceptance record. The types of reward options that were selected frequently by the consumer would rank higher in the order; if there were not enough reward acceptance records to optimize the reward order, the reward options would be ordered according to the distance of the location that provides such reward from the current position of the consumer. The reward options comprise cash coupon (for any goods or service), goods or service coupon, goods or service discount coupon, etc.

Step S305, the server 100 updates the reward acceptance record according to the reward selected from the mobile terminal 200.

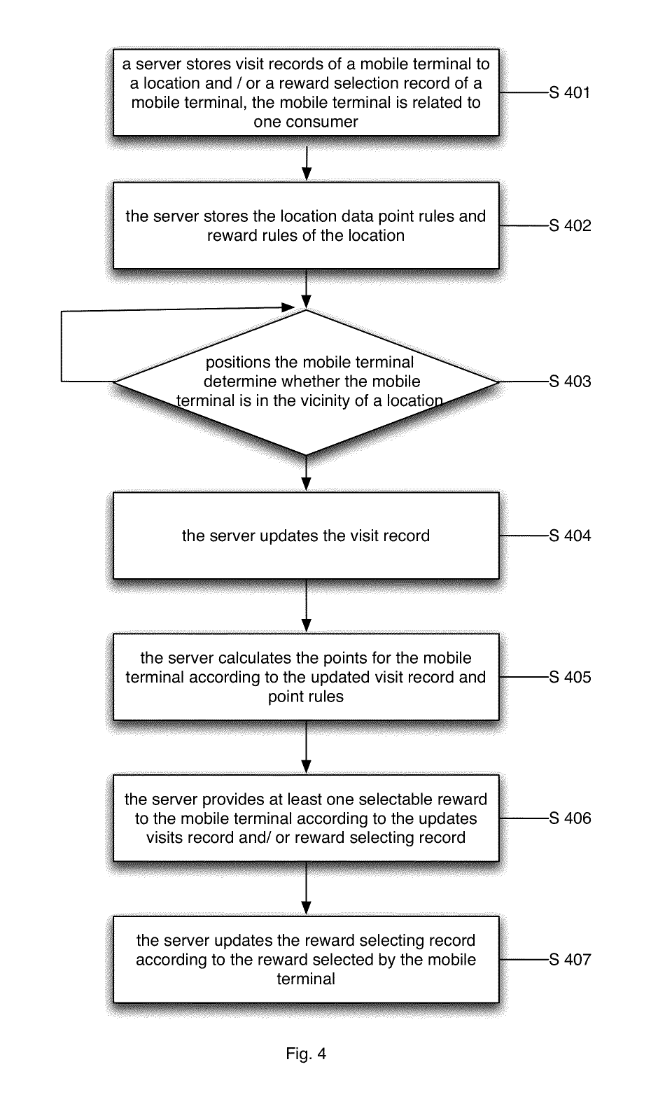

FIG. 4 is the flow chart of the method for consumer location-triggered reward, which could be implemented via the server 100 of reward system and the mobile terminal 200 illustrated in the FIG. 2.

Step S401, the server 100 stores visit records of a mobile terminal 200 to a location and/or reward acceptance record of a mobile terminal 200, and the mobile terminal 200 is related to one consumer. Preferably, a location is a shop and its department.

Step S402, the server 100 stores the location data, reward point rules and reward rules of the location. The location data includes the name of the location, position information, type information and/or operating information of the location. The reward point rules include the maximum number of reward points can be awarded to the mobile terminal 200 for visiting a location in a predefined cycle, such as within one day, one week or one month. When the consumer does not gain any reward points in a location, the visit would still be recorded in the visit record for analyzing the consumer's preference. The reward rules include the shop's data of reward plans, the required reward points of redeeming reward options, reward's expiry, reward's types, and reward's quantity. The reward types include: cash coupon (for any goods or service), goods or service coupon, goods or service discount coupon, etc.

Step S403, positions the mobile terminal 200, determine whether the mobile terminal 200 is in the vicinity of the location. It will proceed to step S404 if it is; otherwise it continues the step S403 to determine location of the mobile terminal 200. Preferably, the server 100 positions the mobile terminal 200 via the outdoor positioning technology and/or the indoor positioning technology.

Step S404, if the mobile terminal 200 is in the location, the server 100 updates the visit record.

Step S405, the server 100 calculates the reward points of the mobile terminal 200 according to the updated visit record and reward point rules.

Step S406, the server 100 provides at least one selectable reward to the mobile terminal 200 according to the updated visit record and/or reward acceptance record. The reward module 30 provides the reward options to the mobile terminal 200 in a descending order according to the reward acceptance record. The types of reward options that were selected frequently by the consumer would rank higher in the order; if there were not enough reward acceptance records to optimize the reward order, the reward options would be ordered according to the distance of the location that provides such reward from the current position of the consumer.

Step S407, the server 100 updates the reward acceptance record according to the reward selected from the mobile terminal 200.

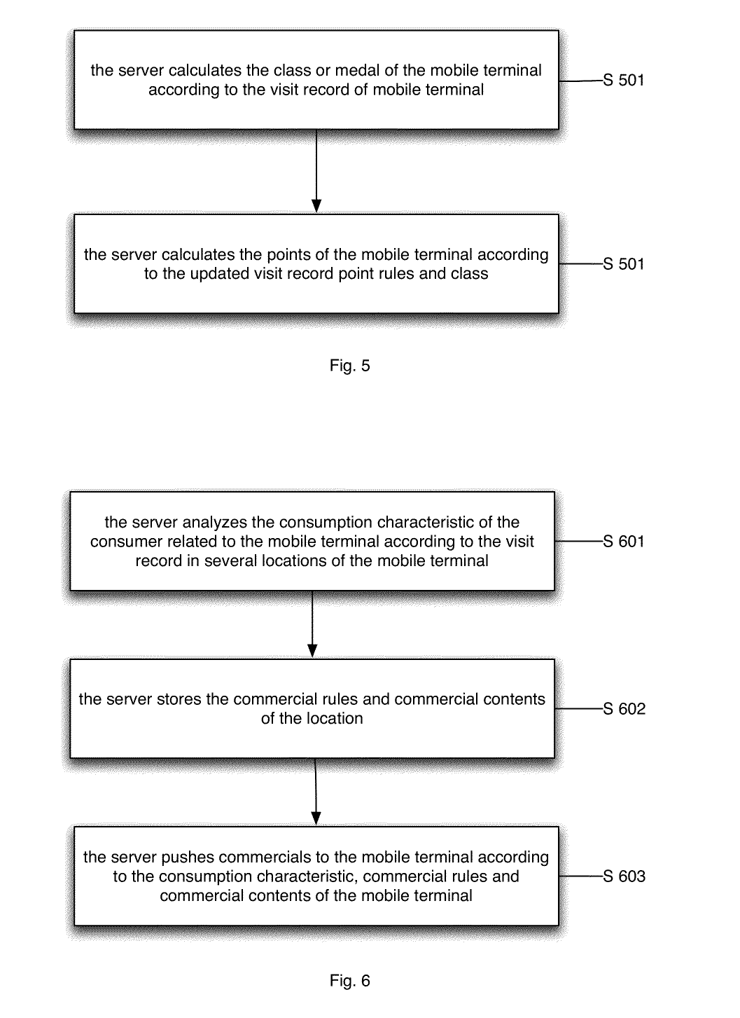

FIG. 5 is the second embodiment of this invention providing the flow chart of the reward points calculating to the mobile terminal 200; it could be implemented via the server 100 of reward system and the mobile terminal 200 illustrated in the FIG. 2, steps comprise:

Step S501, the server 100 calculates the class or medal of the mobile terminal 200 according to the visit record of mobile terminal 200.

Step S502, the server 100 calculates the reward points of the mobile terminal 200 according to the updated visit record, reward point rules and class.

For example, the consumer class could include general consumer, silver consumer, gold consumer and diamond consumer. The consumer class is decided and updated by the reward module 30 according to the data such as the frequency that the consumer visiting the shop. The reward point rules include the reward points that the consumer gains according to his class data, in one embodiment, a silver consumer gains 1.25 times of reward points of a general consumer; a gold consumer gains 1.5 times of reward points of a general consumer; a diamond consumer gains 2 times of reward points of a general consumer.

Moreover, examples of conditions of gaining a medal are: the first five consumers visiting the shop most frequent in a predefined cycle (such as last week, last month, last season), the first five consumers visiting the same arcade (including all shops within the arcade) most frequent in a predefined cycle, the first five consumers visiting the same type of shops (including all daily grocery shops, digital electronic product shops in the same field) most frequent in a predefined cycle.

FIG. 6 is the third embodiment of this invention providing the flow chart of advertisement pushing; it could be implemented via the server 100 of reward system and the mobile terminal 200 illustrated in the FIG. 2, steps comprise:

Step S601, the server 100 analyzes the shopping characteristics of the consumer related to the mobile terminal 200 according to the visit records in several locations of the mobile terminal 200. For example, the analysis module 50 analyzes the shopping preference of the consumer, the type of shops visits (including the daily grocery, electrical appliance, digital electronic product, men clothing, women clothing, kids clothing), the influence of shops visiting preference in weekends and holidays according to the visit record of the consumer.

Step S602, the server 100 stores the advertisement rules and advertisement contents of the location. The advertisement rules comprise: the maximum number of advertisements pushed to the mobile terminal 200 within a predefined timeframe, the upper limit could be set by the system automatically or by the consumer himself in which could enhance the effectiveness of advertisements.

Step S603, the server 100 pushes advertisements to the mobile terminal 200 according to the shopping characteristic, advertisement rules and advertisement contents of the mobile terminal 200.

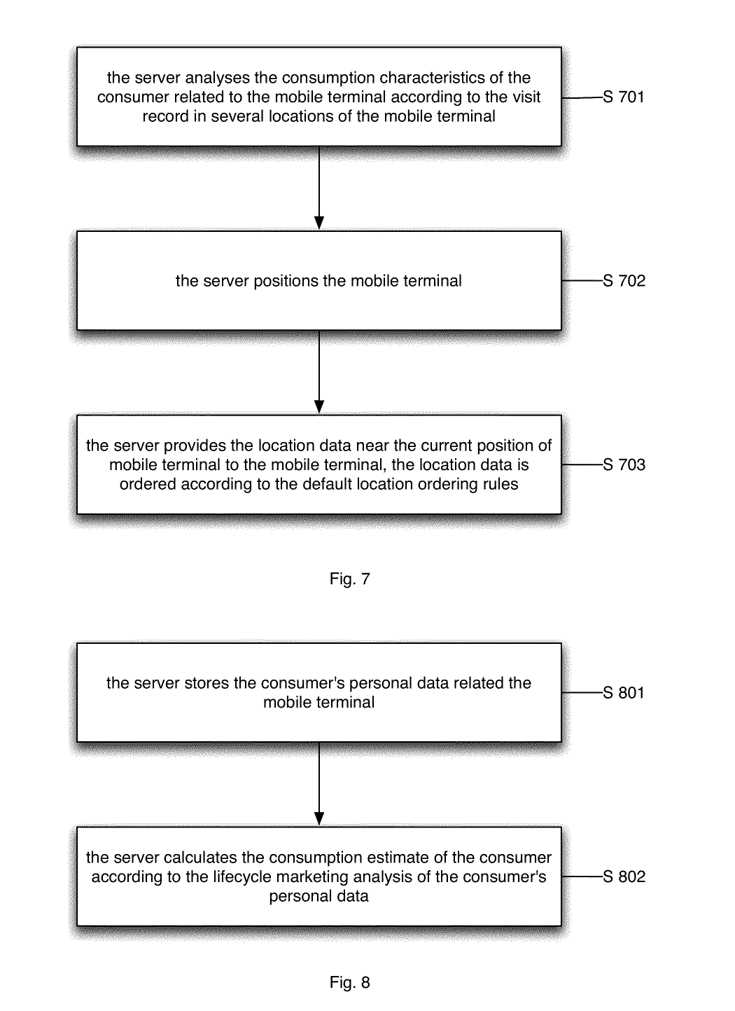

FIG. 7 is flowchart of a fourth embodiment, having location data pushing or shop pushing, implemented using the reward system illustrated in the FIG. 2.

Step S701, the server 100 analyzes the shopping characteristics of the consumer related to the mobile terminal 200 according to the consumer's record of shop visits.

Step S702, the server 100 determines if the current position of mobile terminal 200 is in a shop.

Step S703, the server 100 provides the location shops which are nearby to the current position of mobile terminal 200. The shops are sorted, or ordered, according to predefined shop ordering rules. The shop ordering rules may specify that the shops are arranged according to the shopping preferences of the consumer, or from the nearest to the farthest distance to the mobile terminal 200. The consumer could choose how the shops are ordered via the API communicated by the mobile terminal 200. For example, if the consumer visits digital electronic product shops most frequently in weekends, then digital electronic product shops would be shown in the priority if it were weekend; if the consumer visits daily grocery shops most frequently on Sundays, then daily grocery shops would be shown in the priority if it were Sundays; or if it were about dining hours, the neighboring catering shops would be included in the neighboring shops order.

FIG. 8 is the flow chart of a fifth embodiment which provides lifecycle marketing analysis, implemented via the server 100 of reward system and the mobile terminal 200.

Step S801, the server 100 stores the consumer's personal data related the mobile terminal 200. The consumer's personal data is also known as the consumer's static data that is input and updated by the consumer via the API of the Internet and mobile terminal 200. The consumer's personal data is from the simplest account number and password, to the most comprehensive personal data, including gender, age, income, shopping preference, future shopping plans, housing, family status etc.

Step S802, the server 100 calculates the shopping estimate of the consumer according to the lifecycle marketing analysis of the consumer's personal data. If the personal data is less, the lifecycle marketing analysis is not required.

Accordingly, embodiments have been disclosed in which a mobile terminal may confirm its current location, such as a shop that the consumer who owns the mobile phone is visiting, and according to the visit record and/or reward-selection-record of the consumer to provide an effective and attractive reward according to the consumer's preferences. Also, the reward could be increased according to the consumer's visit frequency to provide the consumer a better shopping experience. Thus, the embodiments provide a personal shopping experience and have a low cost of implementation by relieving the need to rely on creating a CRM (consumer relationship management) database. In other words, the embodiments provide the possibility of a low-cost sharing platform for many shops to reward consumers and thus enhance the competitiveness for small and medium shops. Furthermore, this embodiment could analyze consumer shopping preference consumers with an effective and attractive advertisement according to his preference that enhances the effectiveness of advertisement.

There could be numerous embodiments in accordance with this invention. It is understood that the technicians of related field could make related amends and modifications in accordance with this invention but within the spirit and scope of this invention. Thus, the related amends and modifications are to be limited only by the claims as set forth below.

What is claimed is:

1. A method for providing consumer location-triggered reward points, comprising the steps of:
providing a server;
the server determining whether a mobile terminal belonging to a consumer is in a pre-determined location;
if so, triggering the server to provide at least one reward point to the consumer if the mobile terminal is in the pre-determined location.

2. A method for consumer location-triggered reward as set forth in claim 1, further comprising the steps of:
selecting the at least one reward option from a database of a plurality of reward options, the at least one reward option being redeemable by the reward points of the consumer; and
offering the at least one reward option via the mobile terminal.

3. A method for consumer location-triggered reward as set forth in claim 2, wherein
the at least one reward option is also selected because the reward is provided by pre-determined locations which the mobile terminal were brought to.

4. A method for consumer location-triggered reward as set forth in claim 2, wherein
the at least one reward option is selected because the reward is provided by pre-determined locations of which reward options have been accepted by the consumer in the past.

5. A method for consumer location-triggered reward as set forth in claim 4, further comprising the step of:
ordering the reward options, such that reward options displayed to be seen first are those provided by pre-determined locations of which reward options have been accepted by the consumer in the past.

6. A method for consumer location-triggered reward as set forth in claim 2, wherein
the at least one reward option is selected for the proximity of the nearest pre-determined locations offering the at least one reward option to the present location of the mobile terminal.

7. A method for consumer location-triggered reward as set forth in claim 6, wherein:
reward options are sorted to show those offered by pre-determined locations nearest to the current location of the mobile terminal.

8. A method for consumer location-triggered reward as set forth in claim 6, wherein
there is a pre-determined limit to the number of reward points that can be awarded within a timeframe for making multiple visits to a pre-determined location.

9. A method for consumer location-triggered reward as set forth in claim 1, further comprising the steps of:
awarding a class or medal to the mobile terminal if the mobile terminal has made a minimum number of visits to one or more pre-determined locations.

10. A method for consumer location-triggered reward as set forth in claim 1, comprising the steps of:
the server pushing advertisements to the mobile terminals.

11. A method for consumer location-triggered reward as set forth in claim 10, wherein
the number of advertisements that can be pushed within a predefined timeframe to the mobile terminal is pre-limited.

12. A system for consumer location-triggered reward, wherein the system comprises
a server;
at least one mobile terminal;
the server and mobile terminals being connected via a mobile communication network;
the server comprising:
a consumer database, used for storing records of visit history of a specific place by mobile terminal and/or reward acceptance record made from the mobile terminal, the mobile terminal being related to one consumer;
a positioning module, used for positioning the mobile terminal, and for determining whether the mobile terminal is in the vicinity of the location; if so, the server updates the visit record;
a reward module, used for providing at least one selectable reward to the mobile terminal according to the updated visit record and/or reward acceptance record, and updating the reward acceptance record in the consumer database according to the reward selected from the mobile terminal.

13. A system for consumer location-triggered reward as set forth in claim 12 wherein the location means the pre-determined location or the pre-determined location's departments.

14. A system for consumer location-triggered reward as set forth in claim 13, wherein the server also comprises:
a location database used for storing location data, reward point rules and reward rules;
a reward module comprising:
a reward point sub-module for calculating reward points to award to mobile terminals according to location visit records and reward point rules;
a reward sub-module for providing at least one reward for acceptance to the mobile terminal according to the reward points, reward rules and the reward acceptance record.

15. A system for consumer location-triggered reward as set forth in claim 14, wherein
the reward point rules specify the maximum number of reward points that can be awarded to the mobile terminal for visiting a location within a predefined timeframe.

16. A system for consumer location-triggered reward as set forth in claim 14, wherein
the location data includes the name of the location, position information, type information and/or operating information of the location.

17. A system for consumer location-triggered reward as set forth in claim 14, wherein the reward module also comprises:
class/medal sub-module, used for calculating the class or medal of the mobile terminal according to the visit record of mobile terminal.

18. A system for consumer location-triggered reward as set forth in claim 17, wherein the reward point sub-module calculates the reward points of mobile terminal according to the updated visit record, reward point rules and class.

19. A system for consumer location-triggered reward as set forth in claim 17, wherein the reward module provides the reward options to the mobile terminal in a descending order according to the reward acceptance record.

20. A system for consumer location-triggered reward as set forth in claim 18, wherein the server also comprises:
an analysis module, used for analyzing the pre-determined shopping characteristics of the consumer related to the mobile terminal according to the visit record in several locations of the mobile terminal.

21. A system for consumer location-triggered reward as set forth in claim 20, wherein the location database also stores the advertisement rules and advertisement contents of the location;
the server also comprises an advertisement pushing module, used for pushing advertisements to the mobile terminal according to the pre-determined shopping characteristic, advertisement rules and advertisement contents of the mobile terminal.

22. A system for consumer location-triggered reward as set forth in claim 21, wherein the advertisement rules comprise:
the maximum number of advertisements pushed to the mobile terminal within the predefined timeframe.

23. A system for consumer location-triggered reward as set forth in claim 20, wherein the location pushing module used for providing the location data near the current position of mobile terminal to the mobile terminal. The location data is ordered according to the predefined location ordering rules.

24. A system for consumer location-triggered reward as set forth in claim 23, wherein the location ordering rules comprise that the location data is ordered according to the pre-determined shopping characteristic; or
the location data is ordered from the nearest to the farthest according to the distance between the location and mobile terminal.

25. A system for consumer location-triggered reward as set forth in claim 20, wherein the consumer database also used for storing the consumer's personal data related to the mobile terminal of consumer;
the analysis module also used for analyzing the lifecycle marketing according to the consumer's personal data to calculate the pre-determined shopping estimate of the consumer.

26. A system for consumer location-triggered reward as set forth in claim 12 wherein positioning the mobile position, step comprises:
positioning the mobile terminal via the outdoor positioning technology and/or the indoor positioning technology.
